(19) United States
(12) Patent Application Publication
(10) Pub. No.: US 2024/0049695 A1
(43) Pub. Date: Feb. 15, 2024

(54) ARTIFICIAL BAIT WITH REPLACEABLE SHELL

(71) Applicant: WEIHAI ANDA SPORTS LTD, Weihai (CN)

(72) Inventors: Chenxin Xiao, Weihai (CN); Yihui An, Weihai (CN)

(21) Appl. No.: 18/224,552

(22) Filed: Jul. 20, 2023

(30) Foreign Application Priority Data
Aug. 11, 2022 (CN) 202222106166.4
Aug. 11, 2022 (CN) 202222106170.0

(51) Int. Cl. A01K 85/00

(52) U.S. Cl. CPC A01K 85/029; A01K 85/1837

(57) ABSTRACT

An artificial bait with replaceable shell includes a fish body shell and a detachable integral sheet which are connected up and down, a connecting groove is defined at a bottom of the fish body shell and matches with the detachable integral sheet, the fish body shell and the detachable integral sheet are detachably clamped together to form an entire fish body shape after the detachable integral sheet is clamped into the shell via the connecting groove at the bottom of the shell, achieving that the detachable integral sheet can be repeatedly used while the shells required for different fishing environments can be replaced at will, which can be widely applied to the technical field of fishing gear design.

### CROSS-REFERENCE TO RELATED APPLICATIONS

The present disclosure claims priorities to Chinese Patent Application Nos. 202222106170.0 and 202222106166.4, both filed on Aug. 11, 2022, the entire contents of which are hereby incorporated by reference.

### TECHNICAL FIELD

The present disclosure relates to the technical field of fishing gear design, in particular to an artificial bait with replaceable shell.

### BACKGROUND

Artificial bait is a component made of plastic, metal or other materials with a shape similar to small fish, shrimp and insects. Anglers enable the artificial bait to resemble a natural living creature in the water by means of pulling the artificial bait in the water, luring fierce fish to take the bait. During fishing, the artificial bait is driven to simulate a fish swimming in the water by operation of a fishing rod, thereby achieving a purpose of catching fish. At present, there are many types and colors of artificial baits in the market, and it is necessary to carry multiple artificial baits of different colors for various underwater situations, which is too heavy. The existing artificial bait has a poor operability for underwater use, and is unable to adjust its color according to different underwater situations, which is inconvenient to adjust. The artificial bait can not be adjusted slightly and conveniently according to the changes of the actual water environment, affecting the comfort and experience of fishing.

In addition, most artificial baits cannot be replaced with different painted shells at will. One artificial bait is only configured with a fixed style shell, which cannot meet the fishing needs in different situations. Anglers generally need to prepare multiple artificial baits with different styles of shells, which has disadvantages of inconvenient to carry and high cost. Therefore, it is necessary to provide an artificial bait with a shell that can be easily replaced and with the advantage of strong practicality, convenient carrying and low cost consumption.

Among the existing artificial baits, even if some have a functional structure of a replaceable shell, a painted part of its fish body is limited. Further, the use of artificial bait in fishing requires that the artificial bait sinks in the water, changes of the underwater environment is easy to cause loosen of upper and lower parts of the artificial bait since the easily replaceable snapped connection structure is simple. Counterweight for the existing artificial bait is inconvenient, more can not satisfy the need of practical use.

### SUMMARY

In view of the shortcomings and defects of the prior art, the present disclosure provides an artificial bait with replaceable shell, which is simple and ingenious in structural design and capable of adjusting according to changes of the actual water environment; the shell of the artificial bait can be easily replaced and thus has the advantage of strong practicality, convenient carrying and low cost consumption; color is directly applied to the fish body shell of the artificial bait and thus the overall color looks more natural and realistic, significantly improving the underwater biomimetic effect, finally significantly improving the comfort and experience of fishing, satisfying the need of practical use.

To achieve the above object, the present disclosure is achieved by the following technical solution: an artificial bait with replaceable shell provided by the present disclosure includes a fish body shell and a detachable integral sheet which are connected up and down, a connecting groove being defined at a bottom of the fish body shell and matching with the detachable integral sheet, the fish body shell and the detachable integral sheet being detachably clamped together to form an entire fish body shape after the detachable integral sheet is clamped into the fish body shell via the connecting groove at the bottom of the fish body shell;
a bottom of the whole detachable integral sheet being a fish belly shaped structure, a transverse buckle being provided at a tail of the detachable integral sheet and arranged inwardly, the transverse buckle including a first transverse block and a first transverse slot wherein the first transverse slot is a transverse groove surrounded by the first transverse block and the bottom of the detachable integral sheet and opens forwardly,
a shell body at an internal of a tail of the fish body shell being provided with a second transverse block matching with the first transverse slot and a second transverse primary latching anti-off slot which is a transverse groove surrounded by the second transverse block and a shell bracket over the second transverse block and opens backwardly,
the first transverse block being able to be inserted into the second transverse primary latching anti-off slot, and the second transverse block being inserted into the first transverse slot after clamping is completed.

In some embodiments, a head inside the fish body shell is provided with a secondary stable anti-off slot which matches with a front of the detachable integral sheet.

In some embodiments, a front of the fish belly shaped structure of the detachable integral sheet is provided with a counterweight block, or a weight of the detachable integral sheet is capable of changing according to different shapes or materials of the fish body, or the fish body shell is provided with a sealed cavity for counterweight therein.

In some embodiments, a first hook point is further provided at a bottom of an outer wall which is at the front of the detachable integral sheet and provided with the counterweight block or a plurality of first hook points is provided at the bottom of the detachable integral sheet; and a second hook point is provided at a rear end of the detachable integral sheet.

In some embodiments, one detachable integral sheet is equipped with a plurality of matched fish body shells, and exteriors of the plurality of fish body shells are sprayed with different patterns or colors, respectively; the detachable integral piece is made of corrosion-resistant stainless steel, and the fish body shell is made of ABS.

In some embodiments, the fish body shell is an integral fish body shell formed by fixedly connecting a left fish body shell and a right fish body shell together through ultrasonic welding, a welding surface of each half fish body shell is provided with ultrasonic welding lines, and ultrasonic welding machine welds the left and right fish body shells together through high-frequency vibration heating.

In some embodiments, a clamping manner between the fish body shell and the detachable integral sheet is “rotating-inserting”, and an end of the detachable integral sheet adjacent to a fish head is provided with a support sheet that is arranged upwards and extends out of a top of the fish body shell after assembly,
a back of the fish body shell is provided with a connecting groove that matches with a top of the support sheet, wherein the support sheet is inserted into the fish body shell from a front side of the connecting groove at the bottom of the fish body shell and then extends out of the fish body shell through the connecting groove at the top of the fish body shell;
an upper portion of the support sheet bents backwards, and an inner upper portion of the fish body shell is provided with a position limit portion—the secondary stable anti-off slot, which is clamped with front and rear sidewalls of the support sheet;
a hole is provided in a portion of the support sheet protruding out of the top of the fish body shell, and there are—holes in the support sheet.

In some embodiments, a bottom of a front side of the support sheet is provided with a protrusion that is in interference fit with an interior of the fish body shell.

In some embodiments, a clamping manner between the fish body shell and the detachable integral sheet is transverse insertion, a depressed plate inclined forwardly and downwardly is provided at a bottom of a shell which is located at the front end of the detachable integral sheet and below a mouth of the front end of the fish body shell;
the detachable integral sheet is provided with a support sheet at a front end thereof, and a secondary stable anti-off slot matching with the support sheet is provided between the mouth at the front end of the fish body shell and the depressed plate,
a front end of the support sheet is capable of clamping into the secondary stable anti-off slot at the mouth of the front end of the fish body shell after being inserted into the fish body shell via the connecting groove at the bottom of the fish body shell.

In some embodiments, the depressed plate is a bill with a thickness gradually decreasing from a rear root to the front, a third hole for hanging ring is provided in a portion of the support sheet extending out of the mouth of the fish body shell;
a protrusion is provided on the detachable integral sheet and at a bottom of the first transverse slot, and matches with a sidewall at a bottom of the second transverse block through interfering fitting.

The present disclosure provides an artificial bait with replaceable shell, which has the following beneficial effects:
(1) The artificial bait with replaceable shell of the present disclosure is simple and ingenious in structural design and capable of adjusting a posture of the bait underwater according to changes of the actual water environment, including a size and a position of the counterweight, adjusting a traction position of the fishing line, replacing different fish body shells, etc. The artificial bait has a good operability for underwater use, and the fish body shell can be easily replaced and thus has the advantage of strong practicality, convenient carrying and low cost consumption. The comfort and experience of fishing is significantly improved, thereby satisfying the need of practical use.
   For the artificial bait with replaceable shell of the present disclosure, color is directly applied to the fish body shell of the artificial bait and thus the overall color looks more natural and realistic, significantly improving the underwater biomimetic effect.
(2) The artificial bait with replaceable shell of the present disclosure is clever in structural design and has strong practicality. When facing different fishing situations, anglers do not need to prepare multiple artificial baits with different styles of shells. The artificial bait in hole is assembled by two clamping manners, i.e., “moving-inserting-fixing” or “rotating-inserting-fixing”, which can achieve a stable connection between the fish body shell and the detachable integral sheet. As long as the assembled bait is not bitten by the fish, the fish body shell and the detachable integral sheet are almost never separated. The fish body shell can be replaced according to different fishing environments, which is time-saving and labor-saving, meeting the needs of good experience and comfort of the anglers.
   At the same time, it can reduce the number of purchased matching fishhooks and other accessories, saving some of the cost of purchasing bait accessories for the anglers, achieving the effect that one detachable integral sheet can be repeatedly used and replaced with paint at will.
(3) The functionality of the fish bait mainly depends on the shape and counterweight of the product. The artificial bait with replaceable shell of the present disclosure can choose the counterweight manner according to actual situation, wherein the counterweight block of the detachable integral sheet itself may serve as the counterweight, and counterweight blocks without different weight may be installed in the sealed cavity for counterweight inside the fish body shell, and it is further configured with die-cast metal component to lower its center of gravity, making it easier to achieve the functionality of the fish bait.

### BRIEF DESCRIPTION OF THE DRAWINGS

FIG. 1 is a structure diagram of a first embodiment of the present disclosure.

FIG. 2 is a structure diagram of a front view of a fish body shell of FIG. 1.

FIG. 3 is a structure diagram of a top view of FIG. 2.

FIG. 4 is a structure diagram of a bottom view of FIG. 2.

FIG. 5 is a structure diagram of an exploded view of the fish body shell of FIG. 2.

FIG. 6 is a structure diagram of FIG. 1 before initial assembly.

FIG. 7 is a structure diagram of a horizontal assembly diagram of FIG. 1 in mid-term.

FIG. 8 is a structure diagram of a longitudinal assembly diagram of FIG. 1 in mid-term.

FIG. 9 is a structure diagram of a completed assembly diagram of FIG. 1.

FIG. 10 is a structural diagram of a partially enlarged view of a portion A of FIG. 7.

FIG. 11 is a structure diagram of a second embodiment of the present disclosure.

FIG. 12 is a structure diagram of a fish body shell of FIG. 11.

FIG. 13 is a structure diagram of an exploded view of the fish body shell of FIG. 12.

FIG. 14 is a structure diagram of FIG. 11 before initial assembly.

FIG. 15 is a structure diagram of a horizontal assembly diagram of FIG. 11 in mid-term.

FIG. 16 is a structure diagram of a completed assembly diagram of FIG. 11.

FIG. 17 is a structural diagram of a partially enlarged view of a portion B of FIG. 15.

FIG. 18 is a structure diagram of a third embodiment of the present disclosure.

FIG. 19 shows an usage state of the third embodiment of the present disclosure with fishhooks hanged thereon.

FIG. 20 is a structure diagram of FIG. 19 before initial assembly.

FIG. 21 is a structure diagram of a horizontal assembly diagram of FIG. 19 in mid-term.

FIG. 22 is a structure diagram of a completed assembly diagram of FIG. 19.

FIG. 23 is a structural diagram of a partially enlarged view of a portion C of FIG. 21.

FIG. 24 is a structure diagram of a fourth embodiment of the present disclosure.

FIG. 25 shows an usage state of the fourth embodiment of the present disclosure with fishhooks hanged thereon.

FIG. 26 is a structure diagram of FIG. 25 before initial assembly.

In the drawings:
1 fish body shell
2 detachable integral sheet
3 double-loop connector
4 fishhook
5 left fish body shell
6 right fish body shell
7 ultrasonic welding line
8 sealed cavity for counterweight
9 second transverse primary latching anti-off slot
10 secondary fixing anti-off slot
11 protrusion
12 transverse buckle
13 support sheet
14 first hook point
15 second hook point
16 swivel
17 connecting groove
18 hole
19 depressed plate
20 third hole for hanging ring
1201 first transverse block
1202 first transverse slot
1203 second transverse block

### DESCRIPTION OF THE EMBODIMENTS

Clear and complete description of technical solutions of the embodiments of the present disclosure will be given below with reference to the append drawings. Obviously, the described embodiments are only a part of the embodiments of the present disclosure, not all of them.

In the present disclosure, unless otherwise particularly specified and limited, the terms “connect”, “fixed”, and etc. should be understood in a broad sense. For example, it may be connected fixedly, detachably or integrally; or, it may be connected mechanically or electrically; or, it may be connected directly or indirectly through intermediate media, or may be communication of insides of two components or cooperation relationship of two components. For those skilled in the art, the specific meaning of the above terms in the present disclosure can be understood according to specific circumstances.

### The First Embodiment

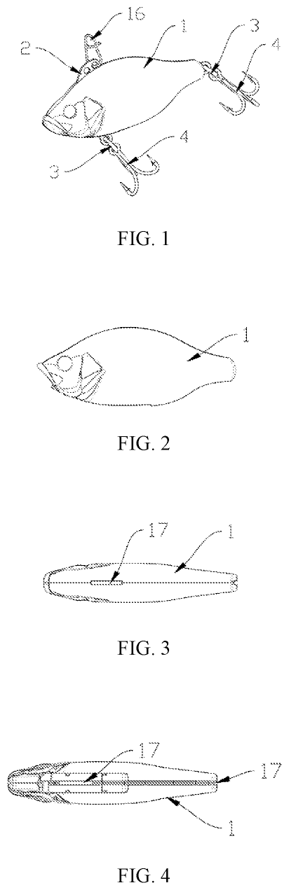

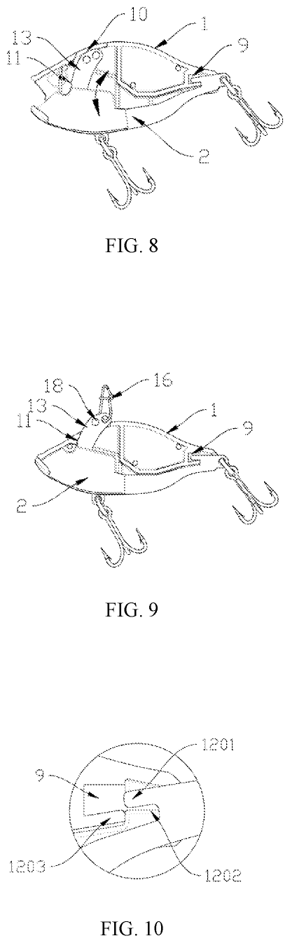

Please referring to FIGS. 1-10, the present disclosure provides a technical solution:

An artificial bait with replaceable shell of the present disclosure includes a fish body shell 1 and a detachable integral sheet 2 which are connected up and down, a connecting groove 17 is defined at a bottom of the fish body shell 1 and matches with the detachable integral sheet 2, the fish body shell 1 and the detachable integral sheet 2 are detachably clamped together to form an entire fish body shape after the detachable integral sheet is clamped into the fish body shell via the connecting groove at the bottom of the fish body shell. Such artificial bait is simple and ingenious in structural design, and easy to implement. The fish body shell 1 and detachable integral sheet 2 in whole are combined through “rotating-inserting-fixing”, a stable connection is thus achieved therebetween, ensuring that the fish body shell 1 and detachable integral sheet 2 are not loose in actual use, meeting the fishing needs of various water environments, facilitating the replacement of the fish body shell 1, assembly and disassembly being convenient. The artificial bait with replaceable shell of the present disclosure is directly colored on the fish body shell 1 thereof, and thus the overall color looks more natural and realistic, significantly improving the underwater biomimetic effect. The fish body shell 1 is made of ABS, which is lightweight and has strong impact resistance, scratch resistance, as well as moisture resistance, corrosion resistance, ease of processing, and etc.

The artificial bait with replaceable shell of the present disclosure may be configured as one detachable integral sheet 2 with a plurality of matched fish body shells 1. External surfaces of the plurality of matched fish body shells 1 are respectively sprayed with different patterns or colors to adapt to different fishing situations. The detachable integral sheet 2 is made of stainless steel, which has stable physical and chemical properties and corrosion resistance. The detachable integral sheet 2 may be cast into one piece, which is easy to process and can prevent water erosion, extending its service life.

A clamping manner between the fish body shell 1 and the detachable integral sheet 2 is “rotating-inserting”. An end of the detachable integral sheet 2 near a fish head is provided with a support sheet 13 which extends upwards and is able to extend out of a top of the fish body shell 1 after assembly. A back of the fish body shell 1 is provided with a connecting groove 17 that matches with a top of the support sheet 13. The support sheet 13 is inserted into the fish body shell 1 from a front side of the connecting groove 17 at the bottom of the fish body shell 1, and then extends out from the connecting groove 17 at the top of the fish body shell 1. An upper portion of the support sheet 13 bents backwards, and an inner upper portion of the fish body shell 1 is provided with a position limit portion—a secondary stable anti-off slot 10, which is clamped to front and rear sidewalls of the support sheet 13 to limit an excessive rotation of the support sheet 13, so as to maintain the support sheet 13 at the best position. Holes 18 are defined in a portion of the support sheet 13 extending out of the top of the fish body shell 1. There are 1-2 holes 18 in the support sheet 13. A bottom of a front side of the support sheet 13 is provided with a protrusion 11, which is in interference fit with an interior of the fish body shell 1, further improving a clamping stability of the fish body shell 1 and the detachable integral sheet 2, and effectively reducing production costs.

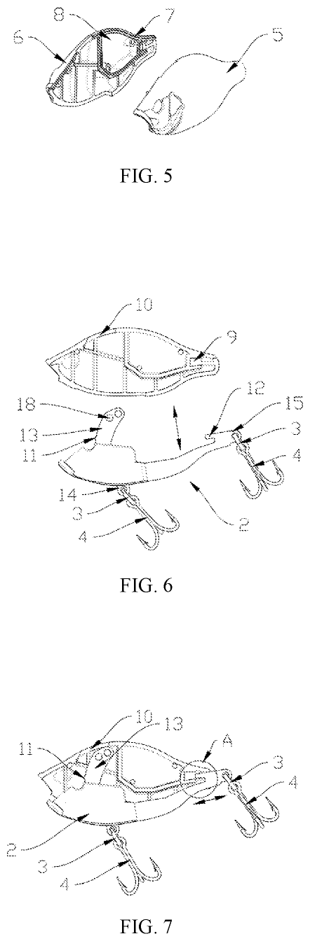

As shown in FIGS. 5-9, in the artificial bait with replaceable shell of the present disclosure, connecting grooves 17 matching with the detachable integral sheet 2 are defined in the tail and back of the fish body shell 1. Two anti-off slots cooperated with each other are provided at the connecting groove 17, namely primary latching anti-off slot 9 and secondary fixing anti-off slot 10, respectively. A bottom of the detachable integral sheet 2 in whole is a fish belly shaped structure. A transverse buckle 12 is provided on the tail of the detachable integral sheet 2 and arranged inwardly. The transverse buckle 12 includes a first transverse block 1201 and a first transverse slot 1202, wherein the first transverse slot 1202 is a transverse groove surrounded by the first transverse block 1201 and the bottom of the detachable integral sheet 2 and opens forwardly. A shell body at an internal of the tail of the fish body shell 1 is provided with a second transverse block 1203 matching with the first transverse slot 1202 and a second transverse primary latching anti-off slot 9 which is a transverse groove surrounded by the second transverse block 1203 and a shell bracket over the second transverse block 1203 and opens backwardly. The first transverse block 1201 may be inserted into the second transverse primary latching anti-off slot 9, and the second transverse block 1203 is inserted into the first transverse slot 1202 after clamping is completed, achieving a stable connection between the fish body shell and the detachable integral sheet. As long as the assembled bait is not bitten by the fish, the fish body shell and the detachable integral sheet will almost never separate.

During in use, for assembly:

As shown in FIGS. 6 to 10, firstly, the detachable integral sheet 2 is inserted into the fish body shell 1 via the connecting groove 17 at the bottom of the fish body shell 1, and the support sheet 13 is inserted into the fish body shell 1 from the front side of the connecting groove 17 at the bottom of the fish body shell 1;

The first transverse block 1201 of the transverse buckle 12 at the tail of the detachable integral sheet 2 is then inserted into the second transverse primary latching anti-off slot 9, and the second transverse block 1203 at the tail of the fish body shell 1 is inserted into the first transverse slot 1202 of the transverse buckle 12 at the same time, achieving a pre-latching operation at the tail of the detachable integral sheet 2.

At the same time, the support sheet 13 at a traction end of the detachable integral sheet 2 is rotated and pushed upwards, and passes through the connecting groove 17 at the top of the fish body shell 1 to achieve that a front of the support sheet 13 of the detachable integral sheet 2 extends through the secondary fixing anti-off hole 10, and the detachable integral sheet 2 is matched and clamped with the fish body shell 1 through interference fit between the protrusion 11 provided at the bottom of the front side of the support sheet 13 of the detachable integral sheet 2 and an internal of the fish body shell 1.

In addition, a swivel 16 is hung on the hole 18 (i.e., functional hole) at an upper end of the traction end of the support sheet 13 of the detachable integral sheet 2 to further ensure that the detachable integral sheet 2 is not easy to slip and fall off, meeting the need of practical use and significantly improving the comfort of fishing. The support sheet 13 is provided with 1-2 holes 18, which can provide different swimming stokes for the artificial bait due to their different positions.

For the artificial bait with replaceable shell of the present disclosure, a counterweight block is provided at the front of the fish belly shaped structure of the detachable integral sheet 2, or a sealed cavity 8 for counterweight is provided inside the fish body shell 1. The sealed cavity 8 for counterweight can be weighted by adding counterweight blocks with different weights according to actual needs, thereby adjusting a density of the whole bait and achieving the effect of sinking and floating speed adjustment of the bait. In addition, sound beads may be placed into the sealed cavity 8 for counterweight to achieve the effect of producing sound during adjusting swinging of the bait in the water. The functionality of the fish bait mainly depends on the shape and counterweight of the product. The artificial bait with replaceable shell of the present disclosure can choose the counterweight manner according to actual situation, wherein the counterweight block of the detachable integral sheet itself may serve as the counterweight, and counterweight blocks without different weight may be installed in the sealed cavity 8 for counterweight inside the fish body shell, and it is further configured with die-cast metal component to lower its center of gravity, making it easier to achieve the functionality of the fish bait.

The counterweight block is stainless steel sheet with lead alloy or zinc alloy casted on its outside, or the detachable integral sheet 2 and the counterweight block are integral, being a tungsten alloy casting part, with strong corrosion resistance and corresponding counterweight effect, which can work in humid atmospheric and seawater media. The counterweight block enables the artificial bait to sink in the water, playing a good counterweight effect. The counterweight block enables the artificial bait to sink in the water to form a sinking state relative to the fish, and enables the artificial bait itself less prone to flipping when pulled by a fishing line, playing a good counterweight effect.

A bottom of an outer wall which is located at the front of the detachable integral sheet 2 and provided with the counterweight block is further provided with a first hook point 14; a second hook point 15 is provided at a rear end of the detachable integral sheet 2, and fishhooks 4 are respectively connected to the first hook point 14 and the second hook point 15 by double-loop connectors 3. The first hook point 14 is further provided at the bottom of the outer wall which is at the front of the detachable integral sheet 2 and provided with the counterweight block; the second hook point 15 is provided at the rear end of the detachable integral sheet 2, both are used to connect fishhooks of various fishing gears and are convenient for fishing use, meeting the needs of different fishing environments, thereby having a wide range of applications.

The fish body shell 1 is an integral fish body shell formed by fixedly connecting a left fish body shell 5 and a right fish body shell 6 together through ultrasonic welding of an ultrasonic welding machine. A welding surface of each half fish body shell is provided with ultrasonic welding lines 7. The ultrasonic welding machine welds the left and right fish body shells 6 together through high-frequency vibration heating.

During in use, for fishing:

Firstly, for the artificial bait with replaceable shell of the present disclosure, a fishing line is connected to the hole 18 at the upper end of the traction end of the support sheet 13 of the detachable integral sheet 2 through the swivel 16. Fishhooks 4 are connected to the first hook point 14 and the second hook point 15 and sink into the fishing water. The process in the water is: the artificial bait in the shape of a fish sinks effectively into the water by means of the counterweight block, making the fishing line connected to the swivel 16 in a tensioned state, so that the artificial bait forms a diving state relative to a normal fish when the artificial bait sinks in the water, which is not prone to flipping.

The positioning of the support sheet 13, the detachable integral sheet 2 and the counterweight block together maintain the stability and simulation performance of the artificial bait in a manner of “inserting-fixing”, improving a fishing effect of the artificial bait. The counterweight block at the front of the fish belly shaped structure of the detachable integral sheet 2 and the holes 18 on the upper end of the support sheet 13 may be changed together to simulate various attitudes of the artificial bait in the water, making the artificial bait in the water better maintain a specific position in a horizontal state, so that the simulation effect is better, cause changes in water flow to bring a simulated wave feeling, the artificial bait is maintained at a normal swimming attitude, forming better simulation effect and thus being easier to attract shoal of fish to take the bait.

The angler may choose and replace the painted shells with different patterns or colors according to the actual fishing environment requirements. The specific operation for replacing the shell are as follows:

detaching the original fish body shell 1: pressing the top of the support sheet 13 at the traction end of the detachable integral sheet 2 downwardly, the detachable integral sheet 2 will be exposed below the fish body shell 1 after the support sheet 13 at the traction end is disengaged from the secondary fixing anti-off slot 10 inside the fish body shell 1, then holding the tail of the fish body and pulling back a hanging ring 5 for the second fishhook 4 at the rear end of the detachable integral sheet 2, thereby the detachable integral sheet 2 can be removed.

New fish body shell 1 that needs to be replaced is reinstalled by repeating the assembly process, the overall operation is simple and convenient, time-saving and labor-saving, significantly improving the fishing experience and comfort of the anglers.

In summary, the artificial bait with replaceable shell provided by the present disclosure is simple and ingenious in structure design, strong practicality, and does not require anglers to configure multiple artificial bait with different styles of fish body shells 1 when facing different fishing environments. The artificial bait in whole is combined by “rotating-inserting-fixing”, and only the fish body shells 1 required for different fishing environments need to be replaced, which is simple and convenient, time-saving and labor-saving, while saving some of the cost of purchasing bait accessories, thereby realizing the effect that one detachable integral sheet 2 can be repeatedly used and freely replaced with different painted fish body shells 1. The color is directly applied to the fish body shell of the artificial bait, making the overall color look more natural and realistic, significantly improving the underwater biomimetic effect. The counterweight manner can be selected according to the actual situation, the center of gravity of the artificial bait is lower, and thus it is easier to achieve the functionality of the bait.

The above are only embodiments of this present disclosure, and the artificial bait with replaceable shell of the present disclosure may be achieved by that, for example, the detachable integral sheet 2 is equipped with a matching number of fish body shells 1, the exteriors of the fish body shells 1 are sprayed with different patterns or colors of coating, the detachable integral sheet 2 is made of corrosion-resistant stainless steel and the fish body shell 1 is made of ABS, the counterweight block is a stainless steel sheet with lead alloy or zinc alloy casted on its outside, or the detachable integral sheet 2 and the counterweight block are integral, being a tungsten alloy casting part.

### The Second Embodiment

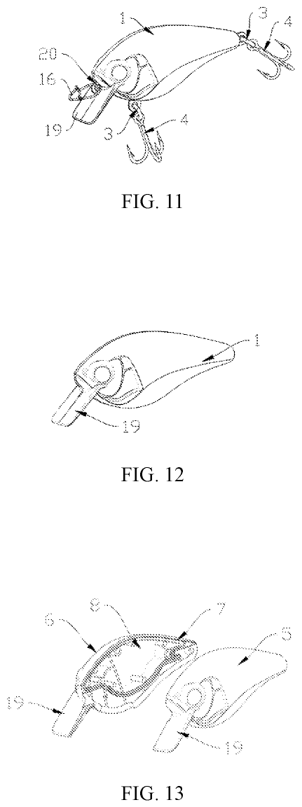

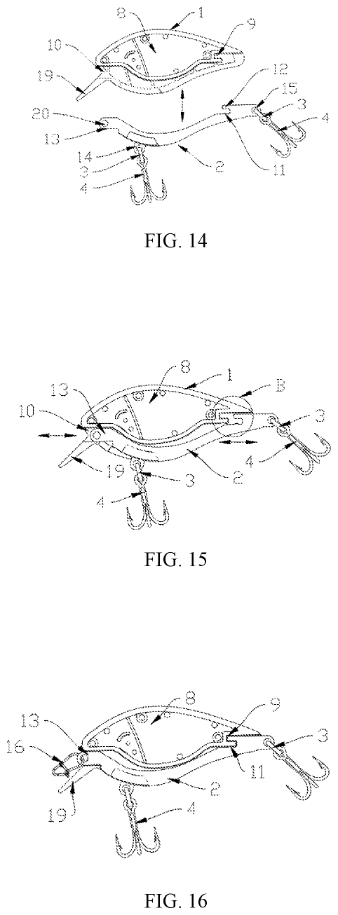

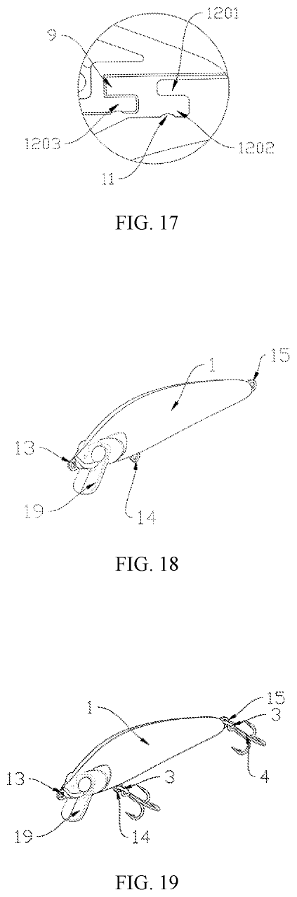

Please referring to FIGS. 11 to 17, another technical solution provided by the present disclosure is as follows: an artificial bait with replaceable shell of the present disclosure is based on that of the first embodiment, wherein the structure and function of the same part as the first embodiment will not be described, and the difference is that:

For this artificial bait with replaceable shell of the present disclosure, the clamping manner between the fish body shell 1 and the detachable integral sheet 2 is transverse insertion, a depressed plate 19 inclined forwardly and downwardly is provided at the bottom of the shell which is at the front end of the detachable integral sheet 2 and below the mouth of the front end of the fish body shell 1. The front end of the detachable integral sheet 2 is provided with a support sheet 13. A secondary fixing anti-off slot 10 is provided between the mouth of the front end of the fish body shell 1 and the depressed plate 19 and matches with the support sheet 13. The front end of the support sheet 13 may extend into the fish body shell 1 via the connecting groove 17 at the bottom of the fish body shell 1, and then clamp into the secondary fixing anti-off slot 10 at the mouth of the front end of the fish body shell 1. This structural design is simple and clever, and easy to implement. The fish body shell 1 and the detachable integral sheet 2 are combined through “moving-inserting-fixing”, which facilitates the replacement of the fish body shell 1 and facilitates assembly and disassembly.

The depressed plate 19 is a bill with a thickness gradually decreasing from the rear root to the front. The support sheet 13 extends outwardly from the mouth of the fish body shell 1 and is provided with a third hole 20 for hanging ring. This design can reduce the resistance of the artificial bait entering the water, and may be used in conjunction with the counterweight block at the front of the fish belly shaped structure of the detachable integral sheet 2 to increase efficiency, making the artificial bait in the water better maintain a specific position in a horizontal state. Especially, it can cause changes in water flow to bring a simulated wave feeling, making the artificial bait be easier for fish to catch.

The first transverse block 1201 can be inserted into the second transverse primary latching anti-off slot 9, and the second transverse block 1203 is inserted into the first transverse slot 1202 after clamping is completed. A protrusion is provided on the detachable integral sheet 2 and at the bottom of the first transverse slot 1202, and matches with a sidewall at the bottom of the second transverse block 1203 through interfering fitting, further improving the clamping stability of the fish body shell 1 and the detachable integral sheet 2, and effectively reducing production costs.

As shown in FIG. 11 to FIG. 15, during assembly, the detachable integral sheet 2 first enters the fish body shell 1 via the connecting groove 17 at the bottom of the fish body shell 1, and then a hanging ring 5 for the second fishhook 4 at the rear end of the detachable integral sheet 2 is pulled backwardly, thereby the detachable integral sheet 2 can be removed.

The first transverse block 1201 of the transverse buckle 12 at the tail end of the detachable integral sheet 2 is aligned with the second transverse primary latching anti-off slot 9, and then the detachable integral sheet 2 is pushed to move forwardly. At the same time, the first transverse block 1201 is inserted into the second transverse primary latching anti-off slot 9 and the second transverse block 1203 at the tail end of the fish body shell 1 is inserted into the first transverse slot 1202 of the transverse buckle 12, and the support sheet 13 at the front end of the detachable integral sheet 2 extends into the secondary fixing anti-off slot 10 between the mouth of the front end of the fish body shell 1 and the depressed plate 19, thereby achieving one-step installation of the detachable integral sheet 2 and the fish body shell 1, which is time-saving and labor-saving, significantly improving the satisfaction and comfort of the artificial bait in actual use, and improving the fishing experience.

For the artificial bait with replaceable shell of the present disclosure, a fishing line is connected to the third hole 20 for hanging ring of the support sheet 13 extending out of the mouth of the fish body shell 1 through the swivel 16. The bottom of the outer wall of the detachable integral sheet 2, which is equipped with the counterweight block, is equipped with a first hook point 14, and the tail of the detachable integral sheet 2 is equipped with a second hook point 15, which are used to connect fishhooks of various fishing gears, facilitating fishing use, meeting the needs of different fishing environments, thereby having a wide range of applications.

The depressed plate 19 is used in conjunction with the counterweight block at the front of the fish belly shaped structure of the detachable integral sheet 2 to increase efficiency, reducing the resistance of the artificial bait entering the water, making the artificial bait in the water better maintain a specific position in a horizontal state, so that the simulation effect is better, cause changes in water flow to bring a simulated wave feeling, the artificial bait is maintained at a normal swimming attitude, forming better simulation effect and thus being easier to attract shoal of fish to take the bait.

The angler may choose and replace the painted fish body shell 1 with different patterns or colors according to the actual fishing environment needs. The specific operation for replacing the shell is as follows:
remove the original fish body shell 1, removing the swivel 16 on the third hole 20 for hanging ring, and then pushing the support sheet 13 on the front end of the detachable integral sheet 2 towards the fish tail, so that the support sheet 13 exits from the secondary fixing anti-off slot 10 between the mouth of the front end of the fish body shell 1 and the depressed plate and enters the fish body shell 1, and the first horizontal block 1201 exits from the second transverse primary latching anti-off slot 9. At this point, the detachable integral sheet 2 is exposed at the tail of the fish body, and will be able to remove by pulling back continuously.

New fish body shell 1 that needs to be replaced is reinstalled and then assembled, the overall operation is time-saving and labor-saving, significantly improving the fishing experience and comfort of the anglers.

The artificial bait with replaceable shell provided by the second embodiment of the present disclosure is simple and ingenious in structure design, strong practicality, and does not require anglers to configure multiple artificial bait with different styles of fish body shells 1 when facing different fishing environments. The artificial bait in whole is combined through “moving-inserting-fixing”, and installation and removal of the fish body shell can be completed in one step. The artificial bait has a good operability for underwater use, and is easier to replace the required shells according to different fishing environments, which is time-saving and labor-saving. The installation is stable and not easy to fall off, saving some of the cost of purchasing bait accessories, meeting the requirements of good experience and comfort of the anglers, achieving the effect that one detachable integral sheet 2 can be repeatedly used and freely match with different coated shells.

### The Third Embodiment

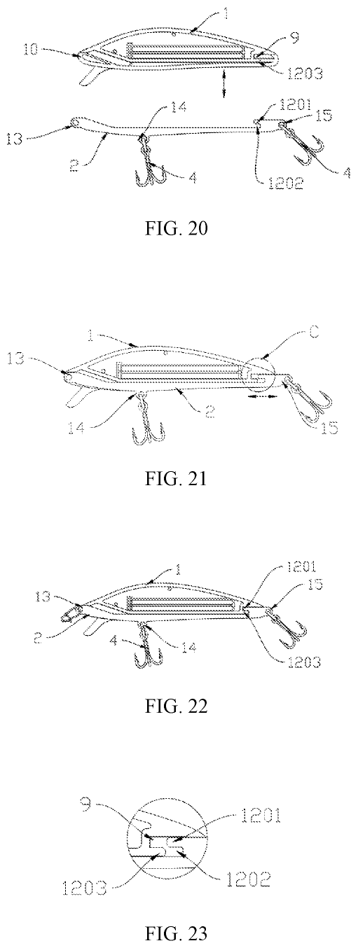

Please referring to FIGS. 18 to 23, the present disclosure provides a technical solution as follows: an artificial bait with replaceable shell of the present disclosure is based on that of the second embodiment, wherein the structure and function of the same part as the second embodiment will not be described, and the difference is that: the fish body shell 1 and detachable integral sheet 2 of the artificial bait with replaceable shell of the present disclosure change with an overall external shape of the artificial bait, meeting the actual needs of fishing waters and fishing for different fish species, further improving the satisfaction and experience of the anglers. The fish body of the artificial bait in the third embodiment is an elongated structure, and the detachable integral sheet 2 is an elongated structure with a shape of flat fish belly. A bottom of the elongated structure with a shape of flat fish belly of the detachable integral sheet 2 is provided with a first hook point 14. In this embodiment, the detachable integral sheet 2 is longer than the detachable integral sheet 2 in the second embodiment, and at the same time the material of the detachable integral sheet 2 is changed, so that the overall weight of the detachable integral sheet 2 in this embodiment is greater than that of the detachable integral sheet 2 in the second embodiment, achieving the goal of shifting the center of the artificial bait with replaceable shell of this embodiment downwards according to the structural design of the slender fish body, which enables the artificial bait to better imitate the smooth movement of slender fish body underwater, resulting in better underwater biomimetic effect, and further improving the satisfaction and experience of the anglers.

Therefore, for the artificial bait with replaceable shell of the present disclosure, the detachable integral sheet 2 can change its weight according to different fish body shapes and materials, resulting in better underwater biomimetic effect and further improving the satisfaction and experience of the anglers.

### The Fourth Embodiment

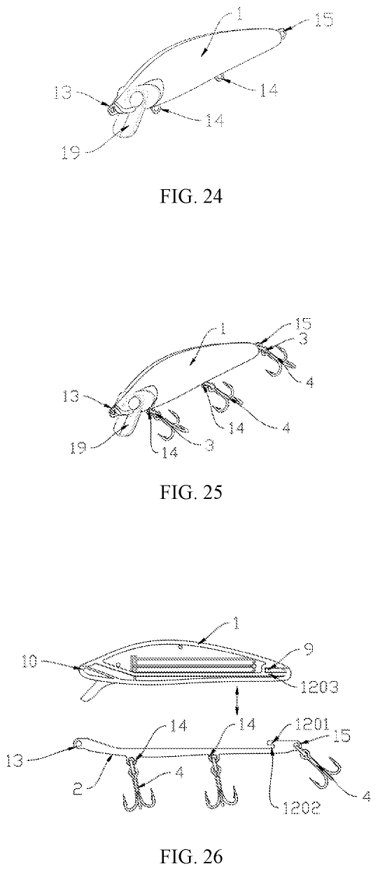

Please referring to FIGS. 24-26, the present disclosure provides a technical solution as follows: an artificial bait with replaceable shell of the present disclosure is based on that of the third embodiment, wherein the structure and function of the same part as the third embodiment will not be described, and the difference is that: two sets of first hook points 14 are provided at a bottom of the detachable integral sheet 2, which increases the fishing probability and further improves the satisfaction and experience of the anglers.

In summary, the artificial bait with replaceable shell of the present disclosure is simple and ingenious in structural design and capable of adjusting a posture of the bait underwater according to changes of the actual water environment, including a size and a position of the counterweight, adjusting a traction position of the fishing line, replacing different fish body shells, etc. Color is directly applied to the fish body shell 1 of the artificial bait, and thus the overall color looks more natural and realistic, significantly improving the underwater biomimetic effect. The artificial bait has a good operability for underwater use, and the fish body shell is connected stably and fixedly, and is easy to replace, improving the comfort and experience of fishing, satisfying the need of practical use

The above description is only preferred specific embodiments of the present disclosure, but the protection scope of the present disclosure is not limited to this. For example, the bottom of the detachable integral sheet 2 is equipped with several first hook points 14, the weight of the detachable integral sheet 2 may be changed according to different fish body shapes and materials, the weight of the counterweight block provided on the fish belly shaped structure of the detachable integral sheet 2 may be changed, or the weight of the counterweight blocks placed in the closed cavity 8 for counterweight of the fish body shell 1 may be changed to realize the artificial bait with replaceable shell of the present disclosure. For any one of those ordinary skilled in the art, within the scope of the disclosed technology, technical solutions that are equivalently replaced or modified according to the technical solutions and inventive concepts of the present disclosure should fall within the scope of the present disclosure.

What is claimed is:

1. An artificial bait with replaceable shell, comprising a fish body shell (1) and a detachable integral sheet (2) which are connected up and down; a connecting groove (17) being defined at a bottom of the fish body shell (1) and matching with the detachable integral sheet (2), the fish body shell (1) and the detachable integral sheet (2) being detachably clamped together to form an entire fish body shape after the detachable integral sheet (2) is clamped into the fish body shell (1) via the connecting groove (17) at the bottom of the fish body shell (1);
a bottom of the whole detachable integral sheet (2) being a fish belly shaped structure, a transverse buckle (12) being provided at a tail of the detachable integral sheet (2) and arranged inwardly, the transverse buckle (12) comprising a first transverse block (1201) and a first transverse slot (1202), wherein the first transverse slot (1202) is a transverse groove surrounded by the first transverse block (1201) and the bottom of the detachable integral sheet (2) and opens forwardly,
a shell body at an internal of a tail of the fish body shell (1) being provided with a second transverse block (1203) matching with the first transverse slot (1202) and a second transverse primary latching anti-off slot (9) which is a transverse groove surrounded by the second transverse block (1203) and a shell bracket over the second transverse block (1203) and opens backwardly,
the first transverse block (1201) being able to be inserted into the second transverse primary latching anti-off slot (9), and the second transverse block (1203) being inserted into the first transverse slot (1202) after clamping is completed.

2. The artificial bait with replaceable shell according to claim 1, wherein a head inside the fish body shell (1) is provided with a secondary stable anti-off slot (10) which matches with a front of the detachable integral sheet (2).

3. The artificial bait with replaceable shell according to claim 1, wherein a front of the fish belly shaped structure of the detachable integral sheet (2) is provided with a counterweight block, or a weight of the detachable integral sheet (2) is capable of changing according to different shapes or materials of the fish body, or the fish body shell (1) is provided with a sealed cavity (8) for counterweight therein.

4. The artificial bait with replaceable shell according to claim 3, wherein a first hook point (14) is further provided at a bottom of an outer wall which is at the front of the detachable integral sheet (2) and provided with the counterweight block or a plurality of first hook points (14) is provided at the bottom of the detachable integral sheet (2); and a second hook point (15) is provided at a rear end of the detachable integral sheet (2).

5. The artificial bait with replaceable shell according to claim 1, wherein one detachable integral sheet (2) is equipped with a plurality of matched fish body shells (1), and exteriors of the plurality of fish body shells (1) are sprayed with different patterns or colors, respectively;
the detachable integral piece (2) is made of corrosion-resistant stainless steel, and the fish body shell (1) is made of ABS.

6. The artificial bait with replaceable shell according to claim 1, wherein the fish body shell (1) is an integral fish body shell formed by fixedly connecting a left fish body shell (5) and a right fish body shell (6) together through ultrasonic welding, a welding surface of each half fish body shell is provided with ultrasonic welding lines (7), and ultrasonic welding machine welds the left and right fish body shells together through high-frequency vibration heating.

7. The artificial bait with replaceable shell according to claim 2, wherein a clamping manner between the fish body shell (1) and the detachable integral sheet (2) is “rotating-inserting”, and an end of the detachable integral sheet (2) adjacent to a fish head is provided with a support sheet (13) that is arranged upwards and extends out of a top of the fish body shell (1) after assembly,
a back of the fish body shell (1) is provided with a connecting groove (17) that matches with a top of the support sheet (13), wherein the support sheet (13) is inserted into the fish body shell (1) from a front side of the connecting groove (17) at the bottom of the fish body shell (1) and then extends out of the fish body shell (1) through the connecting groove (17) at the top of the fish body shell (1);
an upper portion of the support sheet (13) bents backwards, and an inner upper portion of the fish body shell (1) is provided with a position limit portion—the secondary stable anti-off slot (10), which is clamped with front and rear sidewalls of the support sheet (13);
a hole (18) is provided in a portion of the support sheet (13) protruding out of the top of the fish body shell (1), and there are 1-2 holes (18) in the support sheet (13).

8. The artificial bait with replaceable shell according to claim 7, wherein a bottom of a front side of the support sheet (13) is provided with a protrusion (11) that is in interference fit with an interior of the fish body shell (1).

9. The artificial bait with replaceable shell according to claim 2, wherein a clamping manner between the fish body shell (1) and the detachable integral sheet (2) is transverse insertion, a depressed plate (19) inclined forwardly and downwardly is provided at a bottom of a shell which is located at the front end of the detachable integral sheet (2) and below a mouth of the front end of the fish body shell (1);
the detachable integral sheet (2) is provided with a support sheet (13) at a front end thereof, and a secondary stable anti-off slot (10) matching with the support sheet (13) is provided between the mouth at the front end of the fish body shell (1) and the depressed plate (19),
a front end of the support sheet (13) is capable of clamping into the secondary stable anti-off slot (10) at the mouth of the front end of the fish body shell (1) after being inserted into the fish body shell (1) via the connecting groove (17) at the bottom of the fish body shell (1).

10. The artificial bait with replaceable shell according to claim 9, wherein the depressed plate is a bill with a thickness gradually decreasing from a rear root to the front, a third hole 20 for hanging ring is provided in a portion of the support sheet (13) extending out of the mouth of the fish body shell (1);
a protrusion (11) is provided on the detachable integral sheet (2) and at a bottom of the first transverse slot (1202), and matches with a sidewall at a bottom of the second transverse block (1203) through interfering fitting.
